(19) United States
(12) Patent Application Publication
(10) Pub. No.: US 2013/0220918 A1
(43) Pub. Date: Aug. 29, 2013

(54) DOUBLE-LAYER FILTER STRCUTRE

(71) Applicant: Hideo ISHIKURA, Taichung City (JP)

(72) Inventor: Hideo ISHIKURA, Taichung City (JP)

(73) Assignee: INSONIC COMPANY, Taipei City (TW)

(21) Appl. No.: 13/404,080

(22) Filed: Feb. 24, 2012

(51) Int. Cl. B01D 27/06; B01D 29/11

(52) U.S. Cl. 210/489

(57) ABSTRACT

The instant disclosure relates to a double-layer filter structure disposed in an oil filter. The double-layer filter structure includes two individual filter media for removing impurities of different sizes in the engine oil. The double-layer filter structure includes a first filter medium and a second filter medium. The first filter medium has a plurality of wave-shaped and annularly arranged first folding portions. Similarly, the second filter medium has a plurality of wave-shaped and annularly arranged second folding portions. Each of the first folding portions has a mating portion retained by the second folding portions correspondingly.

### BACKGROUND OF THE INVENTION

1. Field of the Invention

The present disclosure is related to a double-layer filter structure. In particular, the present disclosure relates to a filter structure disposed in an oil filter for removing impurities and contaminations from engine oil as it flows from the engine oil pump.

2. Description of Related Art

While an engine is running, the oil used in the engine is exposed to high temperatures and adverse conditions. The engine oil will react chemically and become acidized. Two major types of impurities are produced. One type of impurity is metal particles due to abrasions of engine components during operation, or dusts entered into the engine through the oil-filler port during the refilling process. The other type of impurity is organic matter appeared as black gel-like clay, such as carbon deposition. The oil filter is used to remove impurities from engine oil to keep the engine oil clean. The oil filter includes a filter element made of filtering paper for removing impurities. The filter element is a crucial component that determines the quality of the oil filter.

The conventional filter element is a single layer of filtering paper. However, the impurities in engine oil have different sizes. The conventional filter uses the single-layer filter element to remove impurities of all sizes, where the filtering effectiveness is usually limited.

Therefore, it is desirable to propose a novel filter structure for engine oil to overcome the above-mentioned problems.

### SUMMARY OF THE INVENTION

The present disclosure provides a double-layer filter structure for disposing in an oil filter. The two-piece filter medium is able to remove impurities of different sizes from the engine oil, so that the filtering effectiveness is enhanced.

In order to achieve the above objectives, the present disclosure is to provide a double-layer filter structure, which includes a first filter medium and a second filter medium. The first filter medium has a plurality of first folding portions which are wave-shaped and annularly arranged. Similarly, the second filter medium has a plurality of second folding portions which are wave-shaped and annularly arranged. Each of the first folding portions has a mating portion retained by the second folding portions correspondingly.

Thus, the present disclosure has following advantages. The first filter medium may have enlarged surface area and function cooperatively with the second filter medium to remove impurities of different sizes from the engine oil, so that the filtering capacity and effectiveness are enhanced and the useful lifespan of the oil filter is extended.

For further understanding of the present disclosure, reference is made to the following detailed description illustrating the embodiments and examples of the present disclosure. The description is for illustrative purpose only and is not intended to limit the scope of the claim.

### BRIEF DESCRIPTION OF THE DRAWINGS

FIG. 1 is a perspective exploded view of a double-layer filter structure according to the present disclosure;

FIG. 2 is a perspective assembled view of the double-layer filter element according to the present disclosure;

FIG. 3 is a top view of the double-layer filter element according to the present disclosure; and

FIG. 4 is an assembled view of the double-layer filter structure according to the present disclosure.

### DETAILED DESCRIPTION OF THE PREFERRED EMBODIMENTS

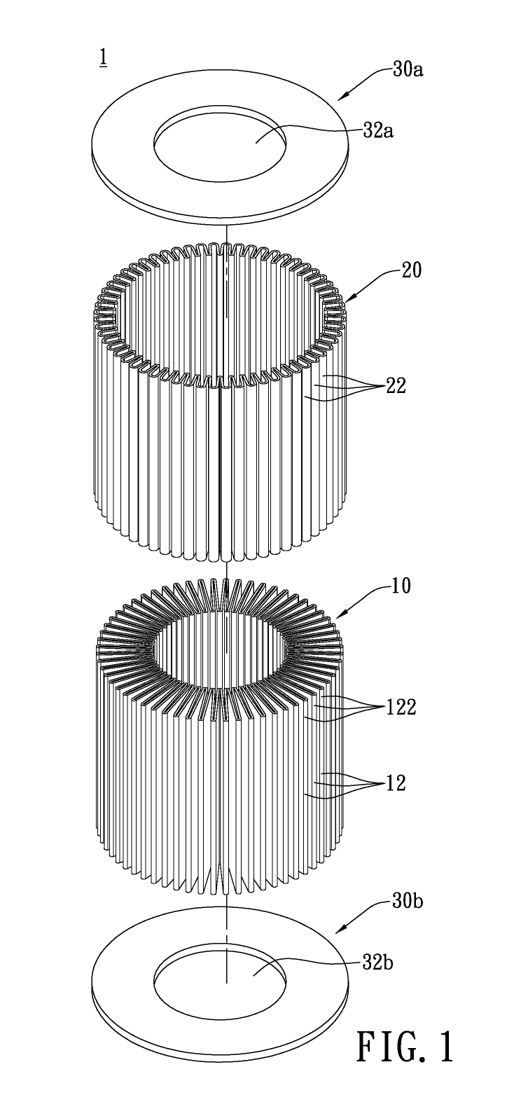

Reference is made to FIG. 1, which is a perspective exploded view of a double-layer filter structure according to the present disclosure. The present disclosure provides a double-layer filter structure 1, which can be mounted in an oil filter (not shown). The double-layer filter structure 1 includes a first filter medium 10, a second filter medium 20 disposed around the first filter medium 10, and a pair of fixing rings 30a, 30b disposed at opposite ends of the first and second filter media 10, 20. The first and second filter media 10, 20 each is hollow and cylinder-shaped. It is supposed that the engine oil flows radially outward from the imaginary center of the double-layer filter structure.

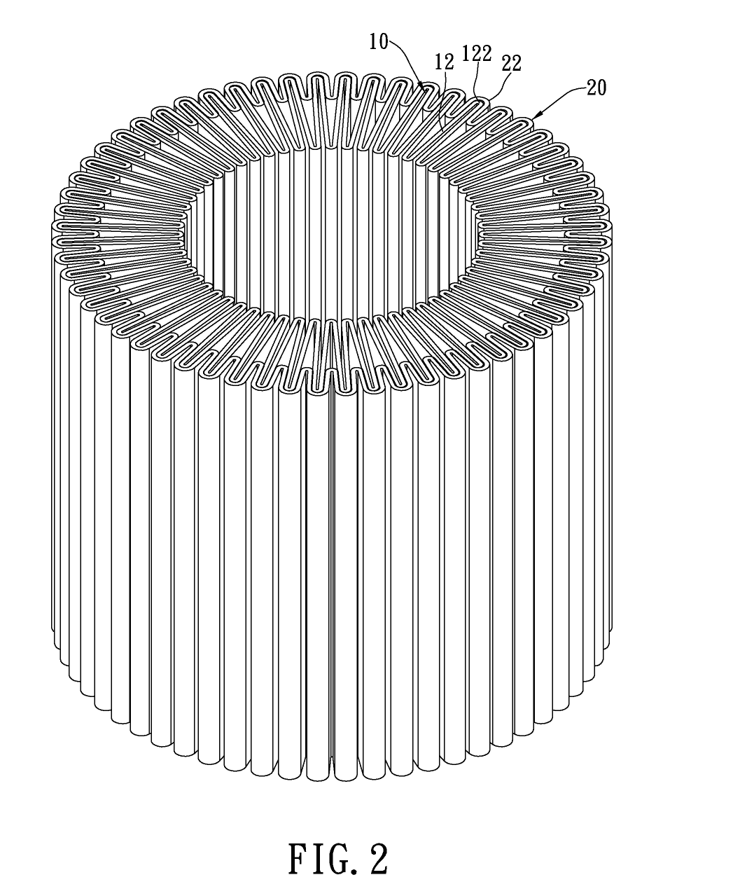

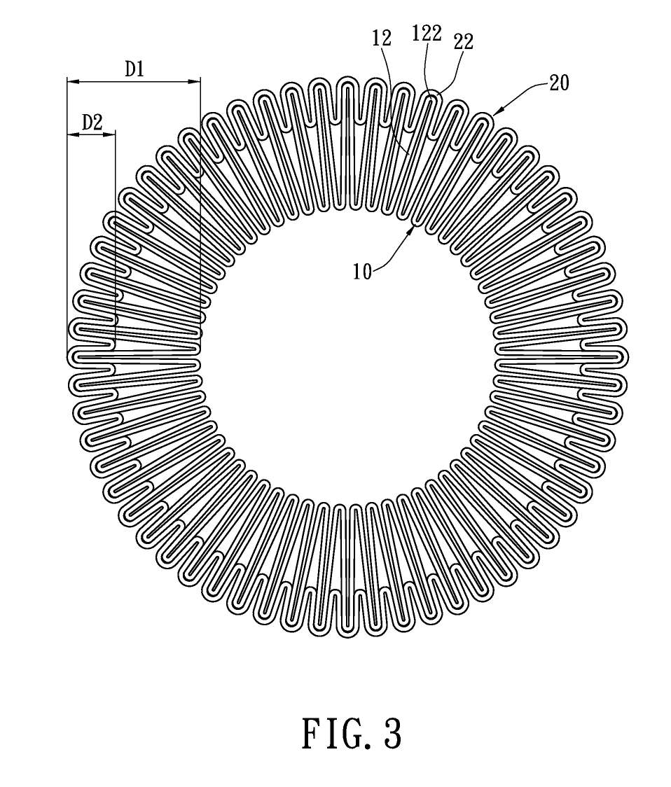

The first and second filter media 10, 20 can be made of fiberglass filter paper, chemical fiber paper, wood pulp filter paper, inorganic fiber filter paper, etc. Please refer to FIGS. 2 and 3, which are perspective assembled and top views of the two-piece filter medium according to the present disclosure, respectively. The first filter medium 10 has a plurality of first folding portions 12 which are wave-shaped and arranged annularly. Similarly, the second filter medium 20 has a plurality of second folding portions 22 which are wave-shaped and annularly arranged. The first filter medium 10 is touchingly surrounded by the second filter medium 20. Each of the first folding portions 12 has a mating portion 122 retained by the second folding portions 22 correspondingly.

In this embodiment, a length D1 along the radial direction of the first folding portion 12 is greater than a length D2 along the radial direction of the second folding portion 22. In other words, the first filter medium 10 has a larger surface area. Comparing with the conventional art, the present disclosure can filter impurities more effectively. Besides, the filter media of the present disclosure preferably have different pore sizes and/or filtration capabilities. For example, the pore size of the second filter medium 20 is smaller than that of the first filter medium 10. Thus, the first filter medium 10 is used to remove relatively large impurities, followed by the second filter medium 20 which is used to remove relatively small impurities.

The surface area of the first filter medium 10 according to the present disclosure is enlarged, and the pore size thereof can be greater than that of the conventional single-layer filter to remove relatively large impurities. Therefore the engine oil can pass through the first filter medium 10 more quickly, thus a high filtering rate can be maintained. The second folding portions 22 of the second filter medium 20 are arranged at the periphery of the first folding portions 12 for removing smaller particles after the first filter medium 10. The pore size of the second filter medium 20 can be smaller than that of the conventional single-layer filter, to be more effective in filtering small particles. It is worth noting the surface area of the second filter medium 20 does not have to be greater than that of the conventional single-layer filter. In other words, the surface area of the second filter medium 20 according to the present disclosure can be smaller than that of the conventional single-layer filter. Thereby, even when the pore size of the second filter medium 20 is smaller than that of the conventional single-layer filter, a high filtering rate can still be maintained. The present disclosure used two filter media 10, 20 that work cooperatively in providing better filtering service.

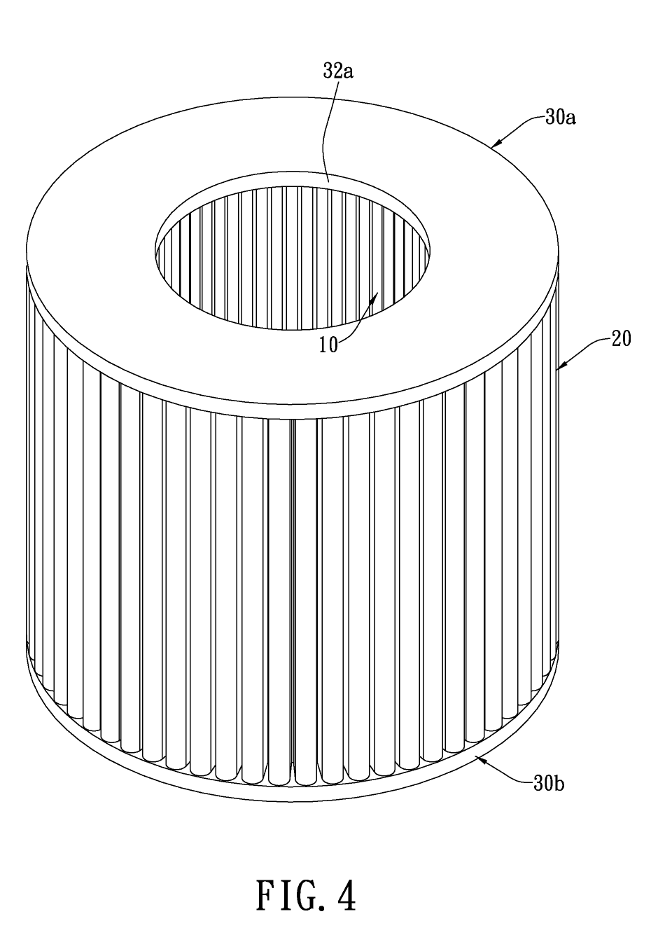

Reference is made to FIGS. 1 and 4, in which FIG. 4 is a perspective assembled view of the double-layer filter structure 1 according to the present disclosure. In this embodiment, the first filter medium 10 and the second filter medium 20 generally have the same height. The fixing rings 30a, 30b are disposed on opposite ends of the first and second filter media 10, 20. Since the first and second folding portions 12, 22 are retained at opposite ends by the fixing rings 30a, 30b, the first and second filter media 10, 20 will not deform easily while in use. The fixing rings 30a, 30b at opposite ends of the first and second filter media 10, 20 also provide the sealing effect, so that the engine oil is forced to flow through the first and second filter media 10, 20 for filtering. The fixing rings 30a, 30b each has a central hole 32a, 32b formed thereon, respectively. The diameter of the central holes 32a, 32b is substantially equal to the inner diameter of the first filter medium 10.

The filtering effectiveness of the conventional single-layer filter is limited, because different sized impurities are filtered by a single layer alone. If the pore size of the conventional filter is reduced to remove small impurities, the filtering rate will be slow down. If the pore size of the conventional filter is too large, small impurities will be left unfiltered. Thus, the engine oil cannot be cleaned effectively, and the performance of the engine will be lowered and may even damage the engine itself. Furthermore, the service life of engine oil will be shortened.

Comparing with the conventional single-layer filter, the double-layer filter structure 1 according to the present disclosure has the first filter medium 10 with larger pore size to remove the impurities of large size, so that the engine oil is filtered quickly by the first filter medium 10. Furthermore, the surface area of the first filter medium 10 is enlarged to enhance the filtering capacity. The second filter medium 20 has smaller pore size for removing relatively small impurity particles, so that the filtering effectiveness is enhanced. The surface area of the second filter medium 20 can be smaller than that of the conventional single-layer filter, so that the filtering rate is not affected. The first filter medium 10 and the second filter medium 20 work cooperatively to remove impurities of different sizes. The useful lifespan of the oil filter can be extended as well.

The description above only illustrates specific embodiments and examples of the present disclosure. The present disclosure should therefore cover various modifications and variations made to the herein-described structure and operations of the present disclosure, provided they fall within the scope of the present invention as defined in the following appended claims.

What is claimed is:

1. A double-layer filter structure, comprising:
a first filter medium having a plurality of wave-shaped and annularly arranged first folding portions; and
a second filter medium having a plurality of wave-shaped and annularly arranged second folding portions, wherein the first filter medium is surrounded by the second filter medium, while each of the first folding portions has a mating portion retained by the second folding portions correspondingly.

2. The double-layer filter structure as claimed in claim 1, wherein the length of the first folding portion is larger than the length of the second folding portion along the radial direction.

3. The double-layer filter structure as claimed in claim 1, wherein the pore size of the second filter medium is smaller than the pore size of the first filter medium.

4. The double-layer filter structure as claimed in claim 1, wherein the first filter medium and the second filter medium have identical height.

5. The double-layer filter structure as claimed in claim 4, further comprising a pair of fixing rings disposed at opposite ends of the first filter medium and the second filter medium, and wherein the first folding portions and the second folding portions are fixed to the fixing rings.

6. The double-layer filter structure as claimed in claim 5, wherein each of the fixing rings has a central hole formed thereon, and wherein the diameter of the central hole is substantially equal to the inner diameter of the first filter medium.
